(19) United States
(12) Patent Application Publication
(10) Pub. No.: US 2003/0080031 A1
(43) Pub. Date: May 1, 2003

(54) Gravel screen

(76) Inventor: Dick Desrosiers, Monmouth, ME (US)

Correspondence Address: Richard C. Litman, LITMAN LAW OFFICES, LTD., P.O. Box 15035, Arlington, VA, 22215, US

(21) Appl. No.: 09/983,720

(22) Filed: Oct. 25, 2001

(51) Int. Cl. B07B 1/46

(52) U.S. Cl. 209/412; 209/408

(57) ABSTRACT

The present invention is a gravel screening device for separating different sizes of gravel and stones or separating gravel and stones from larger rocks. The device comprises a screen supported by a frame with two side walls connected by a low front wall. The screen and the upper edge of each side wall slope downward toward the low front wall. The frame is approximately 10 to 12 feet in width, about 8 feet deep, and supported about 8 feet high by the side walls in the back sloping toward the front wall which is about 4 feet high. The back is open and the edges of the side walls slope outward from the tops of the sidewalls to their bases, thus accommodating a maximum amount of gravel taking into account the angle of repose of the gravel collected in the device.

### BACKGROUND OF THE INVENTION

1. Field of the Invention

The present invention relates to materials separation, More particularly, the present invention relates to screening devices for separating gravel from rocks.

2. Description of the Related Art

Screening assemblies for separating a desired size of gravel and stones from larger rocks presently exist. Many are complicated by screen vibrators, are expensive to build and maintain, and subject to failure. Others suffer from limited throughput and lack ease in loading the screen and recovering the gravel by machines such as front-loaders. It would also be desirable to provide a device providing for the collection of a maximum amount of gravel for a given height of screen, taking account of the angle of repose of a given pile of collected screened gravel held within the device. A further desirable characteristic includes resistance to being physically displaced or damaged by front loaders.

U.S. Des. 263,836, issued Apr. 13, 1982, to Read, describes a portable screening plant, and in particular, FIG. 6 appears to show a gravel screen similar to that of the present invention. The '836 patent, however, has vertical entrance to the interior as compared to the outward sloped entrance of the present invention. The present invention allows for containment of more gravel for the same height of screen structure.

U.S. Pat. No. 4,197,194, issued Apr. 8, 1980, to Read, describes a screening apparatus similar to his design patent above which describes a portable loam screening apparatus that includes a nearly-square sloping shaker screen supported by a boxlike frame. The frame has a tall end and a short end joined by two sides. The short end is closed to provide a wall between separated loam and coarse material.

U.S. Pat. No. 4,923,597, issued May 8, 1990, to Anderson et al. describes a portable screen with a raising and leveling system for raising a frame of the system containing a vibrating screen away from the ground on which the system is positioned.

U.S. Pat. No. 5,921,401, issued Jul. 13, 1999, to Johnston, describes a mobile screening apparatus that may be vibrated by two similarly constructed vibration units. The apparatus has four walls, a coarse upper screen, and a relatively fine lower screen.

None of the above inventions and patents, taken either singularly or in combination, is seen to describe the instant invention as claimed. Thus, a gravel screen solving the aforementioned problems is desired.

### SUMMARY OF THE INVENTION

The present invention is a gravel screening device for separating different sizes of gravel and stones or separating gravel and stones from larger rocks. The device comprises a screen supported by a frame with two side walls connected by a low front wall. The screen and the upper edge of each side wall slope downward toward the low front wall. The frame is approximately 10 to 12 feet in width, about 8 feet deep, and supported about 8 feet high by the side walls in the back sloping toward the front wall which is about 4 feet high. The back is open and the edges of the side walls slope outward from the tops of the sidewalls to their bases, thus accommodating a maximum amount of gravel taking into account the angle of repose of the gravel collected in the device while minimizing the risk of the scoop hitting the underside of the screen. The added footprint to the screen device base allows for resistance to displacement or tipping over of the device.

Accordingly, it is a principal object of the invention to provide a gravel screening device of simple design and minimal maintenance.

It is another object of the invention to provide a gravel screening device which is particularly adapted for use with a front-loading tractor.

It is a further object of the invention to provide a gravel screening device as above which provides for maximum gravel capacity for a given device size.

Still another object of the invention is to provide a gravel screening device as above having a simple and sturdy design while allowing maximum throughput.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a gravel screen device according to the present invention.

FIG. 2 is an environmental side elevation view, partially broken away view, of the screen device of FIG. 1.

FIG. 3 is an environmental rear elevation view of the screen device of FIG. 1.

FIG. 4 is an environmental front elevation view of the screen device of FIG. 1.

Similar reference characters denote corresponding features consistently throughout the attached drawings.

### DETAILED DESCRIPTION OF THE PREFERRED EMBODIMENT

The present invention is a gravel and stones screening device for separating different sizes of gravel or stone or separating gravel stones from larger rocks. The device comprises a screen supported by a frame with two side walls connected by a low front wall. The screen and the upper edge of each side wall slope downward toward the low front wall. The frame is approximately 10 to 12 feet in width, about 8 feet deep, and supported about 8 feet high by the side walls in the back sloping toward the front wall which is about 4 feet high. The back is open and the edges of the side walls slope outward from the tops of the sidewalls to their bases, thus accommodating a maximum amount of gravel taking into account the angle of repose of the gravel collected in the device and allowing for lifting of the front-loading tractor scoop after retrieval or screened gravel while minimizing the risk of the scoop hitting the underside of the screen. The added footprint to the screen device base allows for resistance to displacement or tipping over of the device.

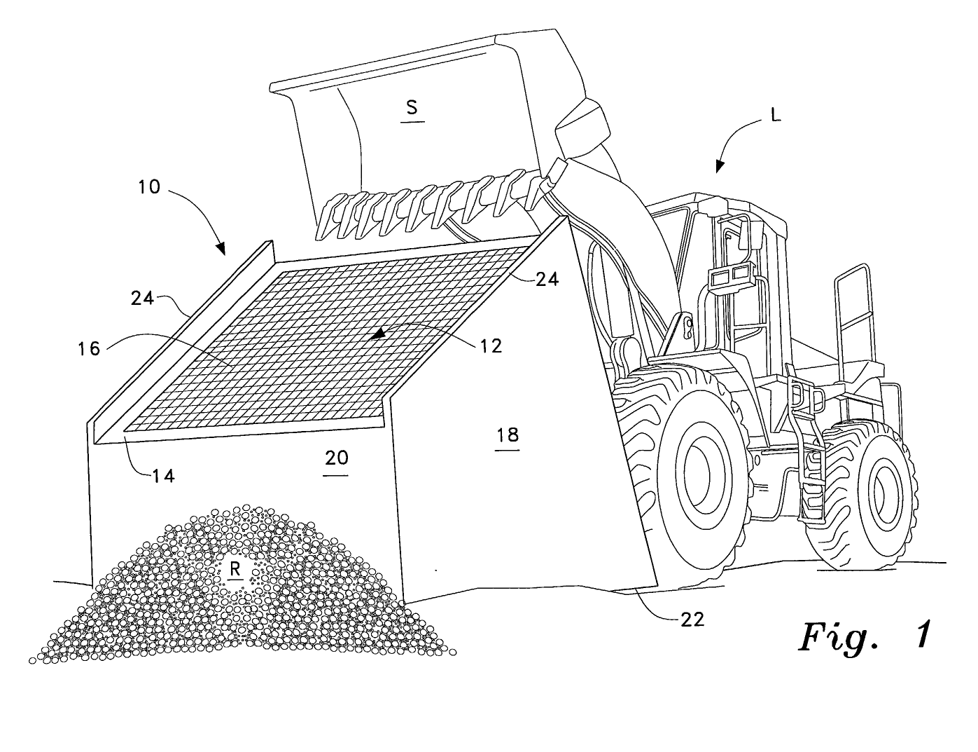

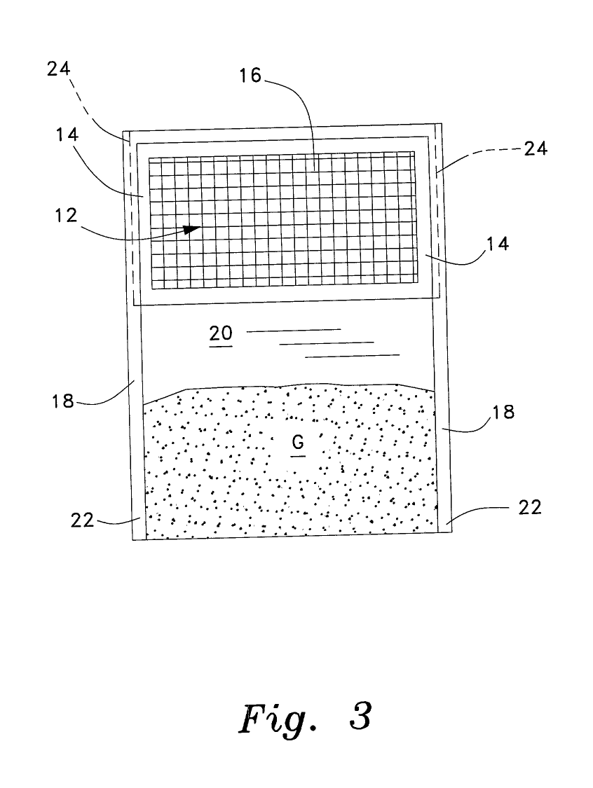

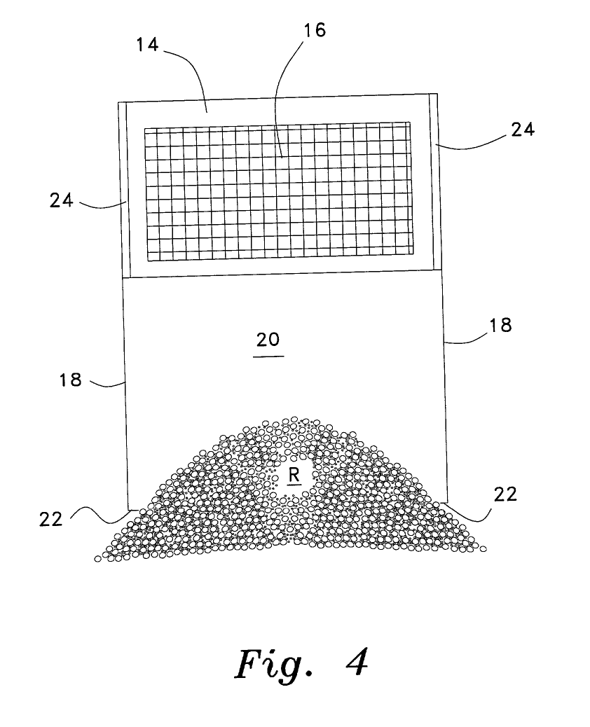

Referring to FIG. 1-4, there is shown a perspective environmental view, partially broken away environmental side elevation view, a rear elevation view and a front elevation view, respectively of the inventive gravel and stone screen device. FIG. 1 portrays the device after processing a load of mixed gravel from front loading tractor L, separating rocks R. Gravel screen device 10 includes gravel screen structure 12 made up of screen frame 14 and screen 16. Screen 16 is supported by sidewalls 18 and front wall 20, sidewalls 18 having bottom end bases 22. Screen structure 12 has guide walls 24 projecting vertically from the portions of screen frame 14 supported by sidewalls 18 acting as an extension thereof.

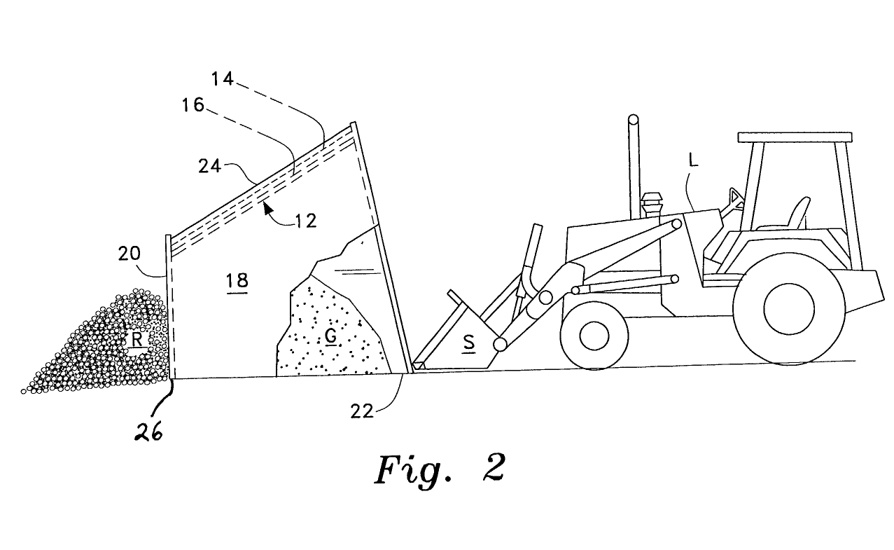

Referring to FIG. 2, front wall 20 has bottom end base 26 laterally even with sidewall bases 22 and therewith support the gravel screen device 10 on any surface such as the earth or a paved surface or pad so as to enclose the pile of separated gravel G. Front loading tractor L may then scoop up the separated gravel by with scoop S by entering through the open rear of the screen device 10 as defined by sidewalls 18 and screen frame 14(see FIG. 5). As seen most clearly in FIG. 2, the rear edges of the sidewalls 18 are not parallel to front wall 20, but slope rearward to permit the gravel screen 10 to encompass more gravel, to provide a more stable base, and to permit clearance for the scoop S at the top of the rear of the gravel screen device 10.

In use, as seen in FIG. 1, front loading tractor L has its scoop S in an elevated position. The operator has just emptied the scoop S to dump the load of mixed gravel and rocks onto screen 12 where the gravel G falls through the screen 12 while the rocks R roll off the front 20 of the screening device 10, as seen in FIGS. 1, 2 and 4. The guide walls 24 keep the gravel and rocks from spilling over the sidewalls 18 and direct the separated rocks downward over front wall 20 to the ground. The scoop S is then lowered to ground level by the operator (see FIG. 2) who then moves the tractor L forward into the screening device 10 enclosure from the rear, fills the scoop S with gravel G, and backs away to deliver the gravel to a desired pile or truck (not shown).

The inventive screening device 10 may be constructed of any suitable materials, the screen preferably being steel, the walls being of steel, cement, or wood. The metal frame of the screen is preferably from about from 10 ft. to 12 ft. in width and about 8 ft. in length. Sidewalls are preferably about 8 ft. in height at the back of the device and, tapering downward to about 4 ft. in height at the front wall. The base of the sidewall may vary but is preferably about 5½ ft. in length for these proportions. The grid work of the screen may be selected from about 12 in.×12 in. to about 2 in.×2 in., depending on the desired range in size of the gravel or stone to be separated.

The slope of the side wall rear edges is preferably about equal to the angle of repose of the collected gravel pile G so as to maximize the capacity of said gravel screen device. The angle of repose is a function of the size and physical character of the gravel or stones being screened. For a given mesh size and the physical character of the gravel or stone being screened the slope of the rear edges of said sidewalls may be selected so as to correspond with the pile angle of repose. The slope should also allow extra clearance for lifting of the gravel-filled scoop of the tractor as it is backing away from the screen device and be sufficient to add to the base footprint to minimize displacement or tipping of the device by the moving tractor scoop.

It is to be understood that the present invention is not limited to the embodiment described above, but encompasses any and all embodiments within the scope of the following claims.

I claim:

1. A gravel and stone screen device, comprising:
a screen having a mesh and a frame;
said frame having a length and a width;
means for supporting said screen at a sloping relation relative to a ground pad;
said means for supporting said screen comprising:
sidewalls supporting said frame along its length;
said sidewalls and said frame defining an open rear portion; and
said sidewalls having respective front edges and rear edges, said rear edges sloping outward from said screen frame to the ground pad;
whereby said open rear portion is of such size and proportions as to provide access for a scoop to enter the interior of said screening device along the ground pad and load and remove separated gravel from a pile of separated gravel formed therein.

2. The screening device of claim 1, wherein said screen frame is rectangular in form and having a front portion, a rear portion, and two spaced side portions.

3. The screening device of claim 2, wherein said support means comprises two directly opposing, parallel, vertical sidewalls.

4. The screening device of claim 3, wherein said support means further comprises a front wall supporting a front portion of said screen frame, said front wall being disposed between and connecting front portions of said sidewalls.

5. The screening device of claim 4, wherein said sidewalls have vertical front edges and said front wall is vertically disposed between said sidewalls.

6. The screening device of claim 5, wherein said slope of said rear sidewall edges is about equal to an angle of repose of a pile of gravel, the angle of repose being determined by the size of said mesh for a given type of gravel or stones being screened.

7. The screening device of claim 2, said screen frame side portions having vertically oriented guide walls along the length thereof.

8. A gravel and stone screening device comprising:
a screen having a given mesh size and supported by a rectangular frame having a side length and front and rear widths;
a front wall and two side walls defining an enclosure having a front portion and a rear portion and supporting said rectangular frame on upper edges of said sides and said front wall such that said screen slopes downward from a rear portion of said enclosure to a front portion thereof;
said side walls having bases. and rear edges sloping outward from said rear width of said screen frame and downward to said bases, respectively defining an opening in said rear portion.

9. The gravel and stone screening device of claim 8, further comprising vertical guide walls along said screen frame lengths.

10. The gravel and stone screening device of claim 8, wherein the slope angle said rear edges of said side walls is about equal to an angle of repose of a pile of gravel or stones passing through said screen and collected within said enclosure.

11. The gravel and stone screening device of claim 8, wherein said enclosure rests on a pad underneath said sidewall bases and the height of said rear width portion of said screen frame is about 8 feet above said pad, said screen frame sloping along its said lengths to said front wall and resting thereon about 4 feet above said pad, said screen frame widths in the range of about 10 feet to about 12 feet in length, said frame lengths being about 8 feet in length, and the base of said sidewalls is about 5½ feet in length.

12. The gravel and stone screening device of claim 11, wherein the mesh size of said screen is in the range of about 2 inches square to about 12 inches square.

13. The gravel and stone screening device of claim 7, wherein the mesh size of said screen is in the range of about 2 inches square to about 12 inches square.

14. The gravel and stone screening device of claim 13, wherein said screen frame side portions are about 8 feet in length, and said screen frame front and rear portions are in the range of about 10 feet and about 12 feet in length, respectively.
